(19) United States
(12) Patent Application Publication
(10) Pub. No.: US 2014/0130495 A1
(43) Pub. Date: May 15, 2014

(54) METHOD FOR OPERATING AN INTERNAL COMBUSTION ENGINE HAVING HIGH PRESSURE AND LOW PRESSURE EXHAUST GAS RECIRCULATION

(71) Applicant: Volkswagen Aktiengesellschaft, Wolfsburg (DE)

(72) Inventors: Ekkehard POTT, Gifhorn (DE); Bernd Hahne, Braunschweig (DE)

(73) Assignee: Volkswagen Aktiengesellschaft, Wolfsburg (DE)

(21) Appl. No.: 14/077,016

(22) Filed: Nov. 11, 2013

(30) Foreign Application Priority Data
Nov. 10, 2012 (DE) 10 2012 022 154.1

(51) Int. Cl. F02M 25/07

(52) U.S. Cl. CPC F02M 25/0709
USPC 60/605.2; 123/568.11; 123/568.12

(57) ABSTRACT

The invention relates to a method for operating an internal combustion engine, a turbine of an exhaust gas turbocharger situated in an exhaust system of the internal combustion engine being driven by exhaust gas from the internal combustion engine, and a compressor of the exhaust gas turbocharger powered by the turbine and situated in a combustion air system of the internal combustion engine compressing combustion air, exhaust gas being diverted in a high pressure exhaust gas recirculation loop upstream from the turbine and mixed with the combustion air downstream from the compressor, exhaust gas being diverted in a low pressure exhaust gas recirculation loop downstream from the turbine and mixed with the combustion air upstream from the compressor, exhaust gas being purified by a low pressure exhaust gas recirculation filter in the LP-EGR loop, a predetermined value for a total exhaust gas recirculation flow.

### CROSS-REFERENCE TO RELATED APPLICATIONS

This application claims priority to German Patent Application No. 10 2012 022 154.1, filed Nov. 10, 2012.

### FIELD OF THE INVENTION

The present invention relates to a method for operating an internal combustion engine, a turbine of an exhaust gas turbocharger situated in an exhaust system of the internal combustion engine being driven by exhaust gas from the internal combustion engine, and a compressor of the exhaust gas turbocharger powered by the turbine and situated in an combustion air system of the internal combustion engine compressing combustion air, exhaust gas being diverted upstream from the turbine and mixed with the combustion air downstream from the compressor in a high pressure exhaust gas recirculation loop (HP-EGR loop), exhaust gas being diverted downstream from the turbine and mixed with the combustion air upstream from the compressor in a low pressure exhaust gas recirculation loop (LP-EGR loop), the exhaust gas being purified by a low pressure exhaust gas recirculation filter (LP-EGR filter) in the LP-EGR loop, a predetermined value for a total exhaust gas recirculation flow (total EGR flow) being determined as a function of an operating state of the internal combustion engine according to the definition of the species in claim 1.

### BACKGROUND OF THE INVENTION

An internal combustion engine having a high pressure exhaust gas recirculation (HP-EGR) and a low pressure exhaust gas recirculation (LP-EGR) is known from DE 10 2011 080 291 A1.This is based on the finding that a turbocharged engine may exhibit higher combustion and exhaust temperatures than a naturally aspirated engine of equivalent output power. Such higher temperatures may increase nitrogen-oxide (NOx) emissions and cause accelerated material aging in the engine and the associated exhaust system. Exhaust gas recirculation (EGR) is one approach for combating these effects. EGR strategies reduce the oxygen content of the intake air charge by diluting it with exhaust gas. When the diluted air-exhaust gas mixture is used in place of ordinary air to support combustion in the engine, lower combustion and exhaust temperatures result. EGR also improves fuel economy in gasoline engines by reducing throttling losses and heat dissipation.

### SUMMARY OF THE INVENTION

In a turbocharged engine system equipped with a turbocharger compressor and a turbine, exhaust gas may be recirculated through a high pressure (HP) EGR loop or a low pressure (LP) EGR loop. In the HP EGR loop, the exhaust gas is diverted upstream from the turbine and mixed with the intake air downstream from the compressor. In the LP EGR loop, the exhaust gas is diverted downstream from the turbine and mixed with intake air upstream from the compressor. HP and LP EGR strategies achieve optimum efficiency in different areas of the engine load-speed map. For example, in turbocharged gasoline engines having stoichiometric air-to-fuel ratios, HP EGR is desirable at low loads, where the intake vacuum provides ample flow potential. LP EGR is desirable at higher loads, where the LP EGR loop provides the greater flow potential. Various other tradeoffs between the two strategies exist as well, both for gasoline and diesel engines. Such complementarity has motivated mechanical engineers to consider redundant EGR systems having both an HP EGR and an LP EGR loop.

A low pressure EGR cooler is situated in the LP-EGR loop, residue from the exhaust system being retained with the aid of a filter (LP-EGR filter) connected upstream in the LP-EGR loop so that a compressor of an exhaust gas turbocharger (EGT compressor) connected downstream from the LP-EGR is not damaged as a result of such residues. The LP-EGR filter is monitored by a differential pressure sensor. If the loss of pressure across the LP-EGR filter exceeds a predetermined threshold value, an engine malfunction is signaled. This leads to an increased number of incidents of damage.

To prevent this, careful manufacture of the exhaust system and exhaust gas treatment is previously provided so that little production residues end up in the LP-EGR loop. However, it is not possible to prevent particle build-up completely during operation over the lifetime of the internal combustion engine.

The object of the present invention is to improve on a method of the aforementioned kind in such a way that fewer engine malfunctions occur as a result of a clogged LP-EGR filter which necessitate undesirably premature service of the internal combustion engine at a specialist repair shop.

### BRIEF DESCRIPTION OF THE INVENTION

It is provided according to the present invention that in a method of the aforementioned kind, at least one operating parameter of the internal combustion engine is determined and a portion of the low pressure exhaust gas recirculation flow (LP-EGR flow) of the total EGR flow and a portion of a high pressure exhaust gas recirculation flow (HP-EGR flow) are determined as a function of the operating parameter. This has the advantage that for any operating state of the internal combustion engine, an optimized emission-neutral operation of the internal combustion engine is ensured.

A further reduction of undesirable emissions is achieved in that the portion of the LP-EGR flow of the total LP-EGR flow is reduced or increased as a function of the operating parameter of the internal combustion engine, and the portion of the HP-EGR flow of the total EGR flow is increased or reduced accordingly, so that the total EGR flow reaches the predetermined value.

In an advantageous embodiment, a value of a degree for a pressure difference, in particular a pressure difference between a first predetermined location upstream from the LP-EGR filter and a second predetermined location downstream from the LP-EGR filter, is determined as the operating parameter of the internal combustion engine. A portion of a low pressure exhaust gas recirculation flow (LP-EGR flow) of the total EGR flow and a portion of a high pressure exhaust gas recirculation flow (HP-EGR flow) are determined as a function of the value of the degree for the pressure difference. This has the advantage that an operating period of the internal combustion engine may be prolonged by postponing a necessary service at a specialist repair shop due to a clogged LP-EGR filter, thereby resulting in lower operating costs of the internal combustion engine. At the same time, an emission-neutral operation of the internal combustion engine is ensured despite the prolonged service interval.

An effective and functionally safe reduction of the value of a degree for a pressure difference is achieved in that with increasing value of a degree for a pressure difference, the portion of the LP-EGR flow of the total EGR flow is reduced and the portion of the HP-EGR flow of the total EGR flow is increased accordingly, so that the total EGR flow reaches the predetermined value.

A targeted prolonging of the service interval to a maximum possible period of time is achieved in that the portion of the LP-EGR flow of the total EGR flow is reduced in such a way that a value for the pressure difference remains below a predetermined value at which a malfunction is signaled. To be able to recognize, if necessary, a need to replace the LP-EGR filter or to take steps to reduce the plaque on the filter during a service visit which takes place anyway, the value of the degree for a pressure difference, is stored in retrievable form.

Further delay in the signaling of an engine malfunction for an arbitrary time span in spite of a clogged LP-EGR filter is achieved in that the LP-EGR flow is set to zero when the predetermined value of the degree for a pressure difference may no longer drop by more than a predetermined value as a result of reduction of the LP-EGR flow.

A portion of the LP-EGR flow is easily replaced by a corresponding increase in the HP-EGR flow by cooling the recirculated exhaust gas in the HP-EGR loop. This ensures that the temperature of the mixture of HP-EGR and charge or combustion air does not appreciably exceed the temperature of the mixture of LP-EGR and charge or combustion air.

In one embodiment, the method according to the present invention may be computer-implemented, wherein a control unit of an internal combustion engine includes a processing unit and a memory unit. A computer program is filed or stored in the memory unit. A method for operating an internal combustion engine having the features or feature combinations of the present invention is carried out with the aid of the computer program when it is at least partially executed in the processing unit.

### BRIEF DESCRIPTION OF THE DRAWINGS

FIG. 1 shows a schematic block diagram of an exemplary specific embodiment of an internal combustion engine for executing the method according to the present invention.

FIG. 2 shows a graphic representation of exhaust gas recirculation flows according to the related art.

FIG. 3 shows a graphic representation of exhaust gas recirculation flows according to the present invention.

### DETAILED DESCRIPTION OF THE INVENTION

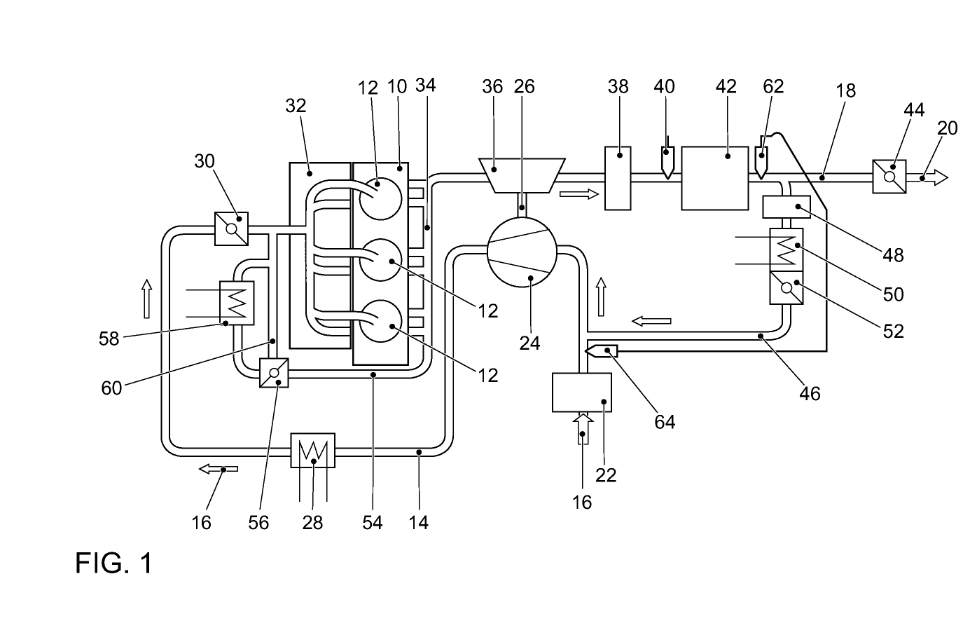

The internal combustion engine shown in FIG. 1 as an example includes an engine block 10 having working cylinders 12, a combustion air system 14 for feeding combustion air 16 to working cylinders 12 and an exhaust system 18 for discharging exhaust gas 20 from working cylinders 12.

Combustion air system 14 includes an air filter 22, a compressor 24 of an exhaust gas turbocharger (EGT) 26, a charge air cooler 28, a throttle valve 30 and an intake manifold 32. Exhaust system 18 includes an exhaust manifold 34, a turbine 36 of EGT 26, a catalytic converter 38, a relative pressure sensor 40, a particle filter 42 which is, in particular, a diesel particle filter DPF, and an exhaust valve 44.

A low pressure exhaust gas recirculation loop (LP-EGR loop) 46 is provided for recirculating exhaust gas, i.e., for reverting exhaust gas 20 from exhaust system 18 back into combustion air system 14. This LP-EGR loop 46 branches off from exhaust system 18 downstream from turbine 36 and joins combustion air system 14 upstream from compressor 24. LP-EGR loop 46 includes a low pressure exhaust gas recirculation filter (LP-EGR filter) 48, a low pressure exhaust gas recirculation cooler (LP-EGR cooler) 50 and a low pressure exhaust gas recirculation valve (LP-EGR valve) 52.

In addition, a high pressure exhaust gas recirculation loop (HP-EGR loop) 54 is provided for recirculating exhaust gas, i.e., for reverting exhaust gas 20 from exhaust system 18 back into combustion air system 14. This HP-EGR loop 54 branches off from exhaust manifold 34 and joins combustion air system 14 downstream from compressor 24. HP-EGR loop 54 includes a high pressure exhaust gas recirculation valve (HP-EGR valve) 56, a high pressure exhaust gas recirculation cooler (HP-EGR cooler) 58 and a bypass line 60 for HP-EGR cooler 58. HD-EGR valve 56 has a dual function, on the one hand it sets a desired high pressure exhaust gas recirculation flow (HP-EGR flow) and, on the other hand, it sets which portion of the high pressure exhaust gas recirculation flow (HP-EGR) flows via HP-EGR cooler 58 and which portion flows uncooled via bypass line 60.

To determine a pressure difference upstream and downstream from LP-EGR filter 48, a first pressure sensor 62 is provided at a first location upstream from LP-EGR filter 48 and a second pressure sensor 64 is provided at a second location downstream from LP-EGR filter 48.

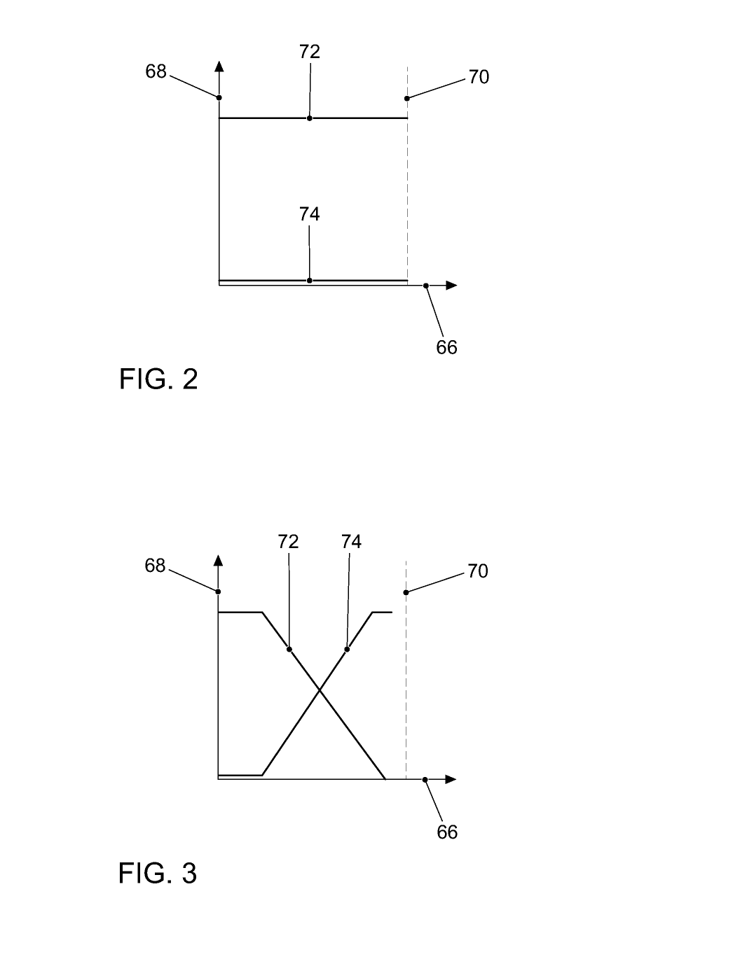

In each of FIGS. 2 and 3, a differential pressure across LP-EGR filter 48 is plotted on a horizontal axis 66, and an exhaust gas recirculation flow (EGR flow) is plotted on a vertical axis 68. Indicated by reference numeral 70 is a predetermined threshold value for differential pressure 66, which signals an engine malfunction. A first graph 72 illustrates a curve of the LP-EGR flow across differential pressure 66, and a second graph 74 illustrates the curve of the HP-EGR flow across differential pressure 66 for an operating state of the internal combustion engine.

For a given operating state of the internal combustion engine, a total exhaust gas recirculation flow (total EGR flow) is determined which is composed of a portion of the HP-EGR flow and a portion of a low pressure exhaust gas recirculation flow (LP-EGR flow). As is apparent from FIG. 2, in the related art each EGR flow 72, 74 is held constant and an engine malfunction is signaled when threshold value 70 for differential pressure 66 is reached.

In an advantageous embodiment, it is provided that the portions of LP-EGR flow 72 and of HP-EGR flow 74 are changed as a function of differential pressure 66 across LP-EGR filter 48 as is apparent from FIG. 3, so that differential pressure 66 remains below threshold value 70. As differential pressure 66 increases, the portion of LP-EGR 72 is reduced and the portion of HP-EGR 74 is increased accordingly, so that the desired total EGR flow is achieved, without at the same time exceeding threshold value 70 for differential pressure 66. This takes place in such a way that, if necessary, the LP-EGR flow is reduced to zero so that threshold value 70 for differential pressure 66 need not be reached, and thus an engine malfunction need not be signaled, as is apparent from FIG. 3.

In other words, a pressure loss-dependent setting of the division of the EGR flow between HP- and LP-EGR takes place, if necessary, until LP-EGR loop 46 is completely shut off.

When the pressure across LP-EGR filter 48 increases, LP-EGR flow 72 is reduced and the HP-EGR flow is simultaneously raised, in such a way that a largely emission-neutral operation of the internal combustion engine is achieved. In any case, exceedance of predetermined OBD emission threshold values (OBD—On Board Diagnosis) is prevented. If necessary, the LP-EGR flow is reduced to zero and the internal combustion engine is run exclusively on HP-EGR. The aim is to avoid an engine malfunction that must be signaled (no so-called “MIL ON”). The pressure increase in LP-EGR filter 48 is stored, for example, in the engine control unit in order to carry out filter replacement and other possible measures for reducing filter plaque during a repair shop visit which takes place anyway.

In an advantageous embodiment, the method according to the present invention is possible, particularly preferably in conjunction with all turbocharged internal combustion engines, such as, for example, diesel or gasoline engines which have an LP-EGR and an LP-EGR filter 48 located upstream thereof, as well as a cooled HP-EGR.

Additionally, any examples or illustrations given herein are not to be regarded in any way as restrictions on, limits to, or express definitions of any term or terms with which they are utilized. Instead, these examples or illustrations are to be regarded as being illustrative only. Those of ordinary skill in the art will appreciate that any term or terms with which these examples or illustrations are utilized will encompass other embodiments which may or may not be given in this specification and all such embodiments are intended to be included within the scope of the present invention.

### LIST OF REFERENCE NUMERALS

10 engine block

12 working cylinder

14 combustion air system

16 combustion air

18 exhaust system

20 exhaust gas

22 air filter

24 compressor

26 exhaust gas turbocharger

28 charge air cooler

30 throttle valve

32 intake manifold

34 exhaust manifold

36 turbine

38 catalytic converter

40 relative pressure sensor

42 particle filter

44 exhaust gas valve

46 LP-EGR loop

48 LP-EGR filter

50 LP-EGR cooler

52 LP-EGR valve

54 HP-EGR loop

56 HP-EGR valve

58 HP-EGR cooler

60 bypass line for HP-EGR cooler 58

62 first pressure sensor

64 second pressure sensor

66 horizontal axis: differential pressure* across LP-EGR filter 48

68 vertical axis: EGR flow

70 predetermined threshold value* for the differential pressure

72 first graph: Curve of LP-EGR flow across differential pressure 66

74 second graph: Curve of HP-EGR flow across differential pressure 66 *Different terms were used in the claims.

1. A method for operating an internal combustion engine, a turbine of an exhaust gas turbocharger situated in an exhaust system of the internal combustion engine being driven by exhaust gas from the internal combustion engine and a compressor of the exhaust gas turbocharger powered by the turbine and situated in a combustion air system of the internal combustion engine compressing combustion air, exhaust gas being diverted in a high pressure exhaust gas recirculation loop upstream from the turbine and mixed with the combustion air downstream from the compressor, exhaust gas being diverted in a low pressure exhaust gas recirculation loop downstream from the turbine and mixed with the combustion air upstream from the compressor, the exhaust gas being purified by a low pressure exhaust gas recirculation filter in the low pressure exhaust gas recirculation loop, a predetermined value for a total exhaust gas recirculation flow being determined as a function of an operating state of the internal combustion engine,
wherein at least one operating parameter of the internal combustion engine is determined, a portion of a low pressure exhaust gas recirculation flow of the total exhaust gas recirculation flow and a portion of a high pressure exhaust gas recirculation flow being determined as a function of a value of the operating parameter.

2. The method of claim 1, wherein the portion of the low pressure exhaust gas recirculation flow of the total exhaust gas recirculation flow is reduced and the portion of high pressure exhaust gas recirculation flow of the total exhaust gas recirculation flow is correspondingly increased as a function of an operating parameter of the internal combustion engine, so that the total exhaust gas recirculation flow reaches the predetermined value.

3. The method of claim 1,
wherein the portion of the low pressure exhaust gas recirculation flow of the total exhaust gas recirculation flow is increased and the portion of high pressure exhaust gas recirculation flow of the total exhaust gas recirculation flow is correspondingly reduced as a function of the operating parameter of the internal combustion engine, so that the total exhaust gas recirculation flow reaches the predetermined value.

4. The method of claim 1,
wherein a value of a degree for a pressure difference between a first predetermined location upstream from the low pressure exhaust gas recirculation flow filter and a second predetermined location downstream from the low pressure exhaust gas recirculation flow filter is determined as the operating parameter of the internal combustion engine in the exhaust system, a portion of a low pressure exhaust gas recirculation flow of the total exhaust gas recirculation flow and a portion of a high pressure exhaust gas recirculation flow high pressure exhaust gas recirculation flow being determined as a function of the value of the degree of the pressure difference.

5. The method of claim 4,
wherein with increasing value of the degree for the pressure difference, the portion of the low pressure exhaust gas recirculation flow of the total exhaust gas recirculation flow is reduced and the portion of high pressure exhaust gas recirculation flow of the total exhaust gas recirculation flow is correspondingly increased, so that the total exhaust gas recirculation flow reaches the predetermined value.

6. The method of claim 5,
wherein the portion of the low pressure exhaust gas recirculation flow of the total exhaust gas recirculation flow is reduced in such a way that a value of the degree for the pressure difference remains below a predetermined value, in which case an engine malfunction is signaled.

7. The method of claim 4,
wherein the value for the value of the degree for the pressure difference is stored in retrievable form.

8. The method of claim 4,
wherein the low pressure exhaust gas recirculation flow is set to zero when the predetermined value (70) for the value of the degree for the pressure difference may no longer drop by more than a predetermined value as a result of a reduction of the low pressure exhaust gas recirculation flow.

9. The method of claim 1,
wherein the recirculated exhaust gas is cooled in the high pressure exhaust gas recirculation flow loop.

10. A control unit of an internal combustion engine, having a processing unit and a memory unit, wherein stored in the memory unit is a computer program, which when at least partially executed by the processing unit, is used to carry out a method for operating an internal combustion engine.
